(19) United States
(12) Patent Application Publication
(10) Pub. No.: US 2001/0032196 A1
(43) Pub. Date: Oct. 18, 2001

(54) System and method for pricing goods

(76) Inventor: Yosef P. Krespi, New York, NY (US)

Correspondence Address: Frank M. Gasparo, Esq., BAKER & McKENZIE, 805 Third Avenue, New York, NY, 10022, US

(21) Appl. No.: 09/746,711

(22) Filed: Dec. 21, 2000

Related U.S. Application Data
(60) Provisional application No. 60/172,816, filed on Dec. 21, 1999.

(51) Int. Cl. G06F 17/60

(52) U.S. Cl. 705/400

(57) ABSTRACT

A method for offering an item to an individual for a reduced price. The method includes receiving a purchase request for the item from the individual, retrieving a pricing model associated with the item from a first database, retrieving information regarding the item from one of the first database and a second database, calculating the reduced price for the item by applying at least a portion of the retrieved information to the retrieved pricing model, and transmitting data indicating the reduced price to the individual.

### CROSS-REFERENCE TO RELATED APPLICATIONS

The present application claims benefit of provisional application No. 60/172,816 filed Dec. 21, 1999.

### FIELD OF THE INVENTION

The present invention relates to a system and method for pricing items and, more particularly, to a system and method for offering an item to an individual at a reduced price based at least on an expiration date of the item.

### BACKGROUND OF THE INVENTION

Developments of alternative healthcare plans such as health maintenance organizations, HMOs, are allowing more people to obtain affordable healthcare. Despite such developments, however, it is estimated that in the United States alone, there are still millions of people who are uninsured and, therefore, cannot receive medication or drugs (hereinafter referred to as drug products) at an affordable price.

Generally, drug products have approximately a two year, and sometimes three year, effectiveness period from the date of manufacture within which the drug products should be taken by the individual. Once expired, the drug products should be disposed of since those drug products that have past the expiration date may lose their potency or even become hazardous due to chemical changes.

What is needed is a system and method for determining prices for items, such as drug products, according to various factors including at least the expiration date of the items and for offering such items to individuals at affordable prices.

### SUMMARY OF THE INVENTION

An aspect of the present invention provides a method for offering an item to an individual for a reduced price. The method includes receiving a purchase request for said item from said individual, retrieving a pricing model associated with said item from a first database, retrieving information regarding said item from one of said first database and a second database, calculating said reduced price for said item by applying at least a portion of said retrieved information to said retrieved pricing model and transmitting data indicating said reduced price to said individual.

### BRIEF DESCRIPTION OF THE INVENTION

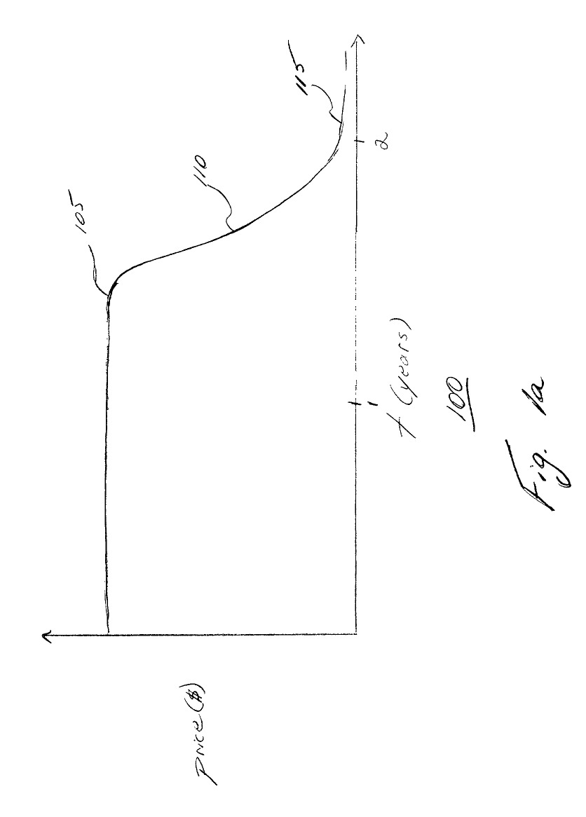

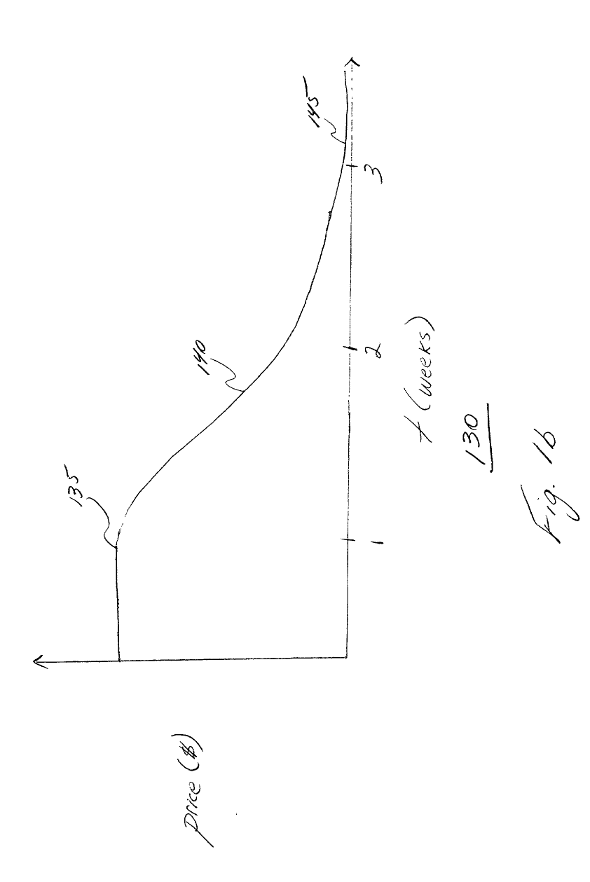

FIG. 1a illustrates an exemplary embodiment of a price versus time graph of the present invention;

FIG. 1b illustrates an exemplary embodiment of a price versus time graph of the present invention;

FIG. 1c illustrates an exemplary embodiment of a price versus time graph of the present invention;

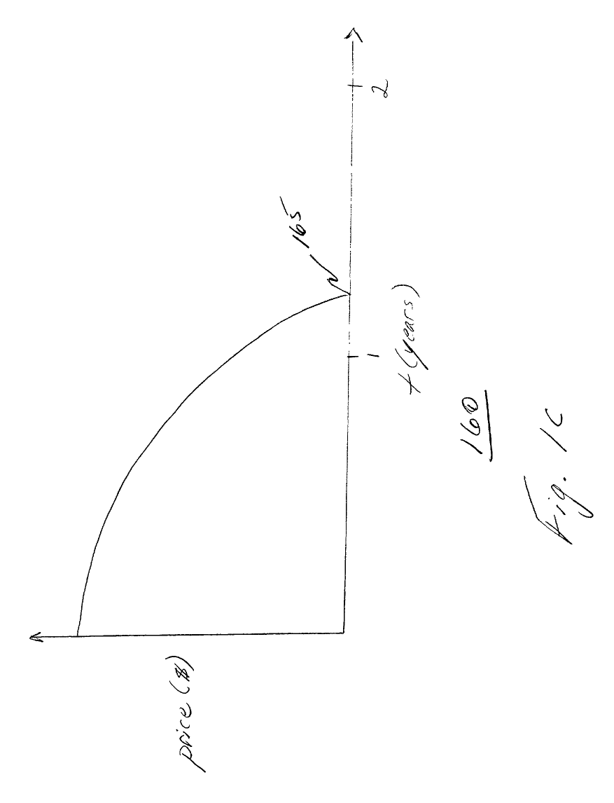

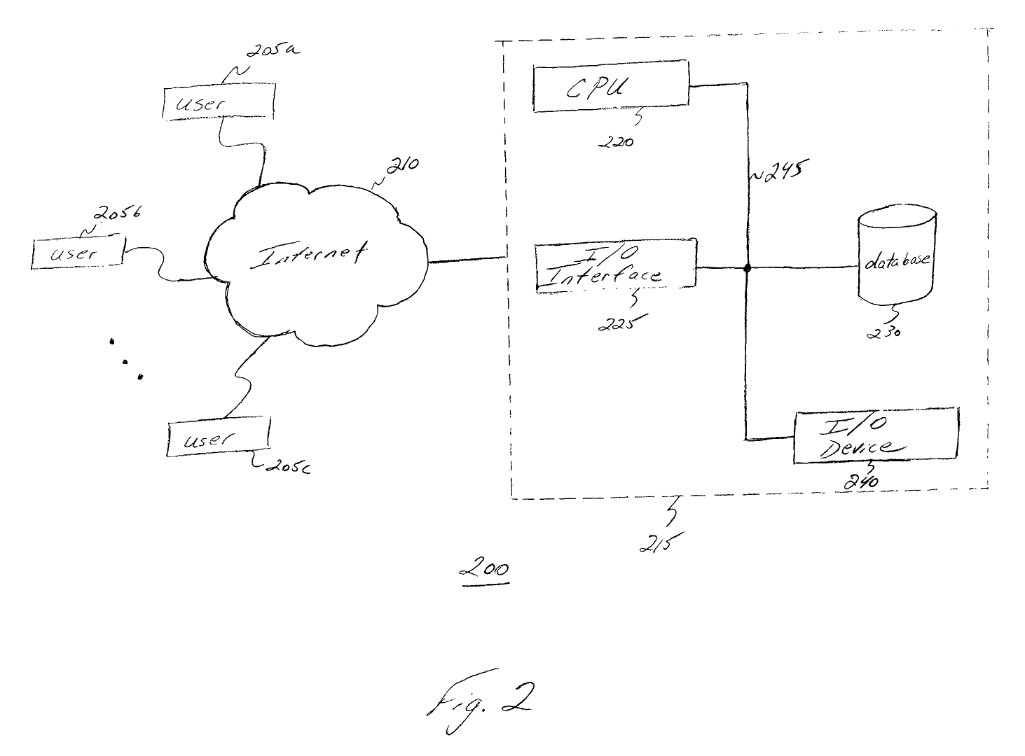

FIG. 2 illustrates an exemplary embodiment of a pricing system of the present invention; and

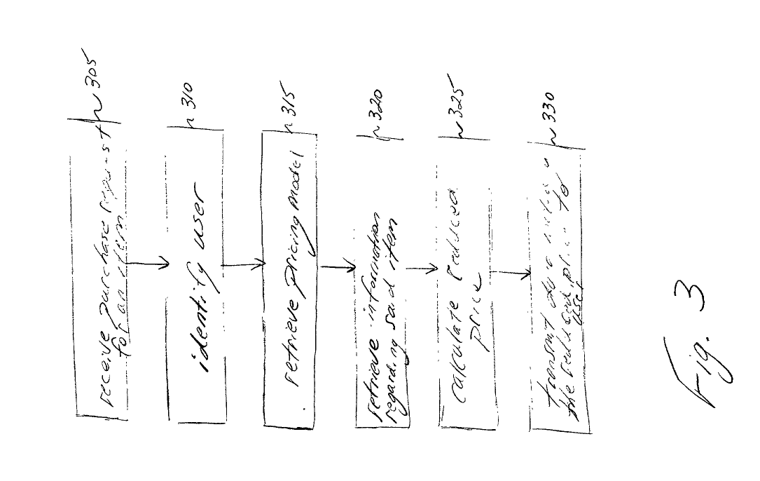

FIG. 3 illustrates an exemplary embodiment of a method for offering an item for a reduced price to an individual of the present invention.

### DETAILED DESCRIPTION

The exemplary embodiments of the present invention are discussed below with reference to the pricing of drug products, either prescription or over-the-counter. The present invention, however, applies to any item having a shelf life, for example, flowers, bread and meat.

FIG. 1a illustrates a price versus time graph 100 of the present invention. Specifically, FIG. 1a depicts how a price of particular drug product with a two year effectiveness period behaves over time. As can be seen in FIG. a, the drug product maintains its price until shortly before the expiration date, that is approximately six months before the expiration date according to market research conducted in the pharmaceutical industry. Starting from about six months before the expiration date, denoted as point 105, the rate of price decline increases until the drug product nearly reaches the expiration date, denoted as point 110, at which time the rate of price decline decreases until the drug product price reaches almost zero at point 115. In an exemplary embodiment of the present invention, as will be appreciated by a person of ordinary skill in the art, the drug product price does not reach zero since there is a buyer or market for the drug product whether inside or outside the United States. In an alternative embodiment of the present invention, the drug product price reaches zero.

For some drug products, or other perishable items such as flowers, a price versus time graph 130 may look like FIG. 1b where the shelf life of the drug product is shorter than the shelf life of the drug product graphed in FIG. 1a. The drug product maintains its price for only a short period of time, for example, approximately one week, as can be seen in FIG. 1b and denoted by point 135. After approximately one week, the rate of price decline for the drug product increases until the drug product nearly reaches the expiration date, denoted as point 140, at which time the rate of price decline decreases until the drug product price reaches almost zero at point 145. In an exemplary embodiment of the present invention, as will be appreciated by a person of ordinary skill in the art, the drug product price does not reach zero since there is a buyer or market for the drug product whether inside or outside the United States. In an alternative embodiment of the present invention, the drug product price reaches zero.

Further, FIG. 1c illustrates a price versus time graph 160 for a drug product or perishable item whose rate of price decline continuously decreases until the drug product price reaches zero at point 165. In an alternative embodiment of the present invention, the drug product price does not reach zero since there remains a buyer or market for the drug product whether inside or outside the United States.

FIG. 2 depicts an exemplary embodiment of a pricing system 200 of the present invention. Pricing system 200 includes computer system 215, such as a WINDOWS-based personal computer, NT Server or a UNIX-based server, for example, a SUN Solarius server. Computer system 215 is connected to one or more users 205a . . . 205n via the Internet 210 and I/O interface 225, such as, for example, a plug-in interface card for a LAN, WAN, fiber optic or cable link, which receives information from and sends information to Internet users and vendors/suppliers. While computer system 215 is shown as a one computer unit for purposes of clarity, persons of ordinary skill in the art will appreciate that computer system 215 may comprise a single box or a group or farm of servers depending on the load and database size.

Computer system 215 also includes, for example, processor (“CPU”) 220, database 230, and one or more I/O devices 240 such as a keyboard, mouse, etc., all commonly connected to each other through bus 245. The software implementing the exemplary method of FIG. 3 is stored in database 230 and/or other storage locations not shown in the drawings and is executed by CPU 220. Database 230 also stores the pricing models used for determining prices of various drug products and user profile data, for example, payment and ordering instructions.

The price of a drug product depends on one or more factors including the manufacture date of the drug product, the packaging date of the drug product, the expiration date of the drug product, the quantity, for example, the number of pills, of a particular package containing the drug product, the duration of time, for example, how many days or weeks, the supply of the drug product represents, whether the drug product is prescription or over-the-counter, the administration method and whether the drug product is branded or generic. Based on one or more of these pricing factors, the pricing behavior of drug products can be modeled by generating pricing models. The pricing models are thereafter stored in a memory location, for example, in database 230, for later retrieval by CPU 220, shown in FIG. 2. As can be appreciated by persons of ordinary skill in the art, the pricing models can involve characterizing the pricing graph as a mathematical formula such as a polynomial with one or more pricing factors as variables. Also, the pricing models can involve storing values (Y, X1, X2 . . . Xn) at various points in time with Xn representing the last variable that affects the drug product price.

FIG. 3 illustrates how drug product price information can be provided to individuals in need of affordable drugs by utilizing one or more pricing models stored in database 230. A user 205a . . . 205n accesses, for example, a main web page of an information provider's web site, such as a host web site, on the Internet through an access provider, such as an Internet service provider. The main web page is hosted by and/or linked to computer system 215. The user 205a . . . 205n then inputs or selects through a main web page or other web page linked thereto a desired drug product and transmits the purchase request to computer system 215 via Internet 210 and I/O interface 225. The user 205a . . . 205n provides sufficient information to identify the desired drug product and the desired quantity. The identification can be made by category or name, or the category or name can be searched for by description through the main web page or web page linked thereto as a person of ordinary skill in the art will appreciate. CPU 220 of computer system 215 receives the purchase request for the particular drug and quantity from the user 205a . . . 205n, in 305. CPU 220 identifies the user 205a . . . 205n who transmitted the purchase request by, for example, referring to an assigned or chosen user identification and password entered by the user 205a . . . 205n, in 310. In an alternative embodiment of the present invention, CPU 220 can also identify the user 205a . . . 205n automatically, for example, by using a cookie file stored in the user's personal computer. As will be appreciated by a person of ordinary skill in the art, any other manner of identifying a user who accesses a computer system via the Internet can be utilized.

In an exemplary embodiment of the present invention, if CPU 220 has identified the user 205a . . . 205n, in 310, it means that the user 205a . . . 205n has registered with the information provider managing or hosting computer system 215 and given certain profile information including payment information and ordering instructions. In that case, it is very easy for the user 205a . . . 205n to place one or more drug product orders through the information provider with no more than a few mouse clicks since pricing system 200 can retrieve the user profile information from database 230 to process the orders without having to ask the same questions to the user 205a . . . 205n such as delivery address and payment information every time an order is placed. In an exemplary embodiment of the present invention, the user profile data includes payment, delivery information, one or more allergies and/or other personal information such as age and gender. In a further exemplary embodiment of the present invention, whether or not CPU 220 has identified the user 205a . . . 205n, the user 205a . . . 205n is prompted to input particular user profile information.

Based on the desired drug product and quantity, CPU 220 retrieves the associated pricing model from a first database, for example, database 230, in 315. CPU 220 also retrieves information regarding the desired drug product including one or more pricing factors from database 230 and/or a second database which may be maintained by the information provider or a third party, in 320. Third parties can include, for example, drug suppliers and manufacturers. The retrieval of the pricing model can also occur after the retrieval of the information regarding the desired drug product. In an exemplary embodiment of the present invention, in order for CPU 220 to retrieve information regarding the desired drug product from a second database of a third party, computer system 215 managed or hosted by the information provider is connected to a system of the third party so that drug product availability, an expiration date and other pricing factors are obtained either periodically or on demand from such third party systems. This allows the information provider's computer system 215 to act as a central distributor of drug products, including drug products that are fairly close to the expiration date. In an alternative embodiment of the present invention, the information regarding the desired drug product is stored in database 230 and the information provider actually carries drug product inventory so that when the user 205a . . . 205n requests pricing information, computer system 215 can not only transmit pricing information to the user 205a . . . 205n, but can also transmit information indicating the availability of the desired drug product for purchase through the Internet from the information provider.

At least a portion of the information regarding the desired drug product that was retrieved, in 320, is incorporated into the associated pricing model retrieved from database 230, in 315. Specifically, in an exemplary embodiment of the present invention, at least a portion of the retrieved information including pricing factors, for example, the manufacture date, the packaging date and the expiration date, is plugged into the associated pricing model by CPU 220 as predetermined variables of a predetermined polynomial. CPU 220 then calculates the reduced pricing information for the desired drug product from the pricing model in 330.

The reduced pricing information is thereafter transmitted to the user 205a . . . 205n via the Internet so that the user 205a . . . 205n can then display and review the transmitted pricing information, in 330. The display can be in the form of a graph, chart, table or the like. As one example, the display can list one or more lines of information including the name of the drug, quantity per package, time elapsed from the manufacture date, effectiveness time remaining and reduced price.

While the pricing system 200 according to the present invention is discussed with the Internet being the primary communication medium, it will be understood that the pricing system can work with any other medium such as e-mail, facsimile or telephone. It is also important to note that while the above discussion refers to pricing of drug products, the same principles apply to any item with a shelf life such as flowers, bread, meat, or the like.

The embodiments described above are illustrative examples of the present invention and it should not be construed that the present invention is limited to these particular embodiments. Various changes and modifications may be effected by one skilled in the art without departing from the spirit or scope of the invention as defined in the appended claims.

What is claimed is:

1. A method for offering a drug product to an individual for a reduced price, comprising:
receiving a purchase request for said drug product from said individual;
retrieving a pricing model associated with said drug product from a first database;
retrieving information regarding said drug product from one of said first database and a second database;
calculating said reduced price for said drug product by applying at least a portion of said retrieved information to said retrieved pricing model; and
transmitting data indicating said reduced price to said individual, wherein
said retrieved information regarding said drug product includes at least one of a manufacturing date of said drug product, a packaging date of said drug product, an expiration date of said drug product, a quantity of a package containing said drug product, a duration of time said quantity represents, whether said drug product is prescription or over-the-counter, an administration method and whether said drug product is generic.
